(19) United States
(12) Patent Application Publication
(10) Pub. No.: US 2017/0261747 A1
(43) Pub. Date: Sep. 14, 2017

(54) HEADS UP DISPLAY OF VEHICLE STOPPING DISTANCE

(71) Applicant: Panasonic Automotive Systems Company of America, Division of Panasonic Corporation of North America, Peachtree City, GA (US)

(72) Inventor: ROBERT ACKLIN, LILBURN, GA (US)

(73) Assignee: Panasonic Automotive Systems Company of America, Division of Panasonic Corporation of North America

(21) Appl. No.: 15/066,125

(22) Filed: Mar. 10, 2016

(51) Int. Cl. G02B 27/01; G01S 13/08; G01C 19/00; B60R 1/00

(52) U.S. Cl. CPC G02B 27/0101; B60R 1/00; G01S 13/08; G01C 19/00; B60R 2300/205; B60R 2300/8086; G02B 2027/0141; G02B 2027/014

(57) ABSTRACT

A heads up display arrangement for a motor vehicle includes a wheel sensor sensing a speed of rotation of a wheel. A distance-sensing device senses a distance between the motor vehicle and an other vehicle that is in front of the motor vehicle relative to a direction of travel of the motor vehicle. A processor receives the sensed speed of rotation of the wheel and calculates dependent thereon a stopping distance of the motor vehicle. A heads up display presents an image indicative of both the calculated stopping distance of the motor vehicle and the sensed distance between the motor vehicle and the other vehicle.

### CROSS-REFERENCE TO RELATED APPLICATIONS

This application claims the benefit of U.S. Provisional Application No. 62/132,422 filed on Mar. 12, 2015, which the disclosure of which is hereby incorporated by reference in its entirety for all purposes.

### FIELD OF THE INVENTION

The disclosure relates to a heads up display for a motor vehicle.

### BACKGROUND OF THE INVENTION

A heads up display in a motor vehicle typically displays only the vehicle speed. Thus, a heads up display is underutilized in terms of the information it may provide to a driver.

### SUMMARY

Disclosed herein is a heads up display (HUD) that provides a graphical and/or spatial indication of how much distance a first vehicle needs in order to come to a stop at its current speed relative to the distance to a second vehicle that the first vehicle is following. For example, the HUD may display a horizontal line indicating how much distance the first vehicle needs to stop during hard braking based on the first vehicle's current speed. Also displayed may be an indication of the position of the closest other vehicle (second vehicle) in front of the first vehicle relative to the first vehicle's required stopping distance. That is, the HUD may indicate whether the first vehicle has enough distance to stop and avoid hitting the second vehicle in front of the first vehicle in the event that the second vehicle in front comes to an immediate stop, as may be the result of an accident involving the second vehicle. The HUD may indicate how much more stopping distance is needed to avoid hitting the second vehicle in a hard braking scenario, or how much extra stopping distance is available to avoid hitting the second vehicle in a hard braking scenario.

In one embodiment, the invention comprises a heads up display arrangement for a motor vehicle including a wheel sensor sensing a speed of rotation of a wheel. A distance-sensing device senses a distance between the motor vehicle and an other vehicle that is in front of the motor vehicle relative to a direction of travel of the motor vehicle. A processor receives the sensed speed of rotation of the wheel and calculates dependent thereon a stopping distance of the motor vehicle. A heads up display presents an image indicative of both the calculated stopping distance of the motor vehicle and the sensed distance between the motor vehicle and the other vehicle.

In another embodiment, the invention comprises a method of operating a heads up display in a motor vehicle, including detecting a speed of rotation of a wheel of the motor vehicle. A distance between the motor vehicle and an other vehicle that is in front of the motor vehicle relative to a direction of travel of the motor vehicle is sensed. A stopping distance of the motor vehicle is calculated dependent upon the detected speed of rotation of the wheel. An image indicative of both the calculated stopping distance of the motor vehicle and the sensed distance between the motor vehicle and the other vehicle is presented on the heads up display.

In yet another embodiment, the invention comprises a heads up display arrangement for a motor vehicle including means for sensing a speed of the motor vehicle. A distance-sensing device senses a distance between the motor vehicle and an other vehicle that is in front of the motor vehicle relative to a direction of travel of the motor vehicle. A processor receives the sensed speed of the motor vehicle and calculates dependent thereon a stopping distance of the motor vehicle. A display device presents an image indicative of both the calculated stopping distance of the motor vehicle and the sensed distance between the motor vehicle and the other vehicle.

An advantage of the invention is that it may prevent a driver from getting too close to the car in front of him, and may thereby provide enough space for the driver's vehicle to come to a complete stop before hitting the car in front of the driver's vehicle.

Although a forward looking radar could tell the driver the distance to the car in front of him and if he is too close to that car, the forward looking radar alone does not display the information to the driver and does not relate the distance to the car in front of him to the stopping distance required for his vehicle based on the vehicle's current speed.

Another advantage of the invention is that it provides easily perceived graphical and/or spatial information that enables the driver to judge for himself whether he is allowing enough stopping distance between him and the car in front of him.

Yet another advantage is that the weight of the vehicle may be taken into account in calculating the stopping distance. For example, the manufactured weight of the vehicle, which may be known when the inventive system is installed and initialized, may be entered into the inventive system and taken into account in calculating the stopping distance.

### BRIEF DESCRIPTION OF THE DRAWINGS

A better understanding of the present invention will be had upon reference to the following description in conjunction with the accompanying drawings.

FIG. 1 is a block diagram of one example embodiment of a heads up display system of the present invention.

FIG. 2 is a schematic view of an example embodiment of a heads up display of FIG. 1.

### DETAILED DESCRIPTION OF THE PREFERRED EMBODIMENTS

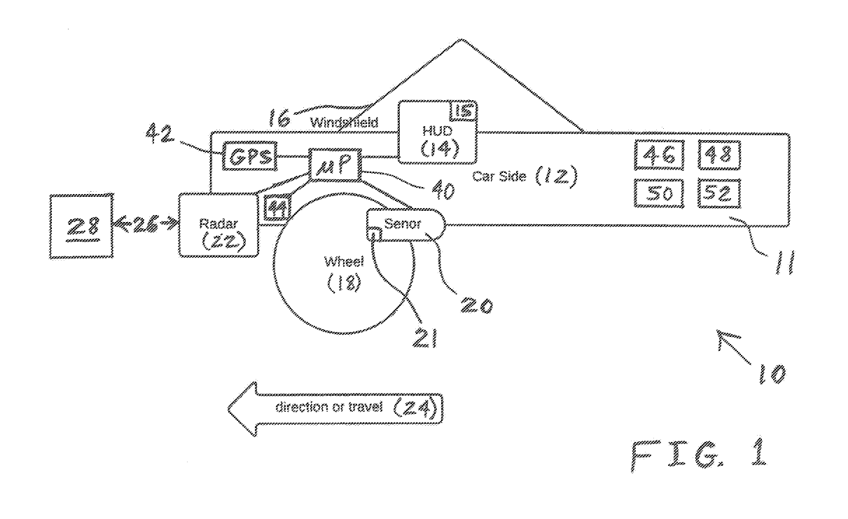

FIG. 1 illustrates one embodiment of a heads up display arrangement 10 of the present invention including a vehicle 11 having a body side 12, a heads up display (HUD) module 14 having a processor 15, a windshield 16, a wheel 18, a wheel sensor 20, a radar device 22, a central processor 40, a global positioning system 42, a brake sensor 44, an ambient outside temperature sensor 46, a moisture sensor 48, a traction sensor 50, and an ambient light sensor 52. The vehicle 11 generally travels in a forward direction 24.

During use, as the vehicle 11 travels in direction 24, radar device 22 determines a distance 26 between the vehicle 11 and a second vehicle 28 that vehicle 11 is following. Radar device 22 may communicate the calculated distance 26 to HUD module 14. Simultaneously with the operation of radar device 22, wheel sensor 20 may sense the speed of rotation of wheel 18 and may calculate therefrom a stopping distance in which vehicle 11 would come to a stop in the event that the driver of vehicle 11 applies the brakes of vehicle 11 as hard as possible. Wheel sensor 20 may include a processor 21 to perform such calculations. The driver may apply the brakes as hard as possible, for example, in response to seeing second vehicle 28 de-accelerate quickly, come to a stop, and/or be involved in a collision. Wheel sensor 20 may communicate this calculated stopping distance to HUD module 14. Alternatively, wheel sensor 20 may communicate only the sensed speed of rotation of wheel 18 to HUD 14, and processor 15 of HUD 14 may calculate the stopping distance. The stopping distance may be calculated dependent upon the weight of vehicle 11 as manufactured and/or upon signals from ambient outside temperature sensor 46, moisture sensor 48, traction sensor 50, and/or ambient light sensor 52.

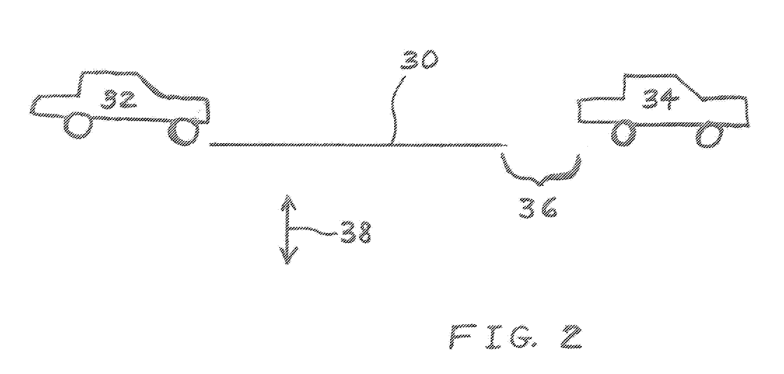

In response to receiving distance 26 from radar device 22 and the stopping distance from wheel sensor 20, HUD module 14 may project a display onto windshield 16, an example of which is depicted in FIG. 2. The display may include a horizontal line 30 the length of which is proportional to the calculated stopping distance. An indication 32 of the position of vehicle 11 at the beginning of the path that vehicle 11 travels while braking may also be provided. Near the opposite end of the path, the display may also include an indication 34 of the present position of the vehicle 28 that vehicle 11 is behind or following. Accordingly, the combination of the horizontal line 30 and the indication 34 of the position of vehicle 28 may inform the driver of vehicle 11 whether he would have enough space to come to a stop and avoid hitting vehicle 28 in the event that vehicle 28 came to an immediate stop. For example, a space 36 between horizontal line 30 and indication 34 of the position of vehicle 28 may indicate the extra distance that would be between vehicle 11 and vehicle 28 if the driver of vehicle 11 were to hit the brakes as hard as possible and come to a stop. Conversely, if there is overlap (e.g., at least partial alignment in vertical directions 38 of the display) between horizontal line 30 and indication 34 of the position of vehicle 28, it may indicate the additional stopping distance that would be required in order to avoid vehicle 11 colliding with vehicle 28 in the event that the driver of vehicle 11 hits the brakes as hard as possible to thereby attempt to come to a stop before colliding with vehicle 28.

In some embodiments, wheel sensor 20 and/or HUD 14 may take into account current weather conditions and/or the driver's reaction time when calculating the length of line 30 that should be presented on the display projected onto windshield 16. For example, vehicle 11 may include a temperature sensor and moisture sensor in order to determine whether it is currently raining or snowing, and perhaps to determine the intensity with which the rain or snow is coming down. Wheel sensor 20 and/or HUD 14 may take into account whether it is raining or snowing, and possibly the intensity of such precipitation, when calculating the length of line 30. As another example, vehicle 11 may include a traction sensor to determine how slick the roadway is on which vehicle 11 is traveling. Wheel sensor 20 and/or HUD 14 may take into account the traction on the roadway when calculating the length of line 30. As yet another example, wheel sensor 20 and/or HUD 14 may take into account a typical driver's reaction brake time (i.e., the time between the event that the driver sees and the time at which the driver applies the brakes), which may be approximately between 1.5 and 2.3 seconds. In one embodiment, HUD 14 tests and stores each individual driver's reaction brake time, and uses this tested and stored driver reaction brake time when calculating the length of line 30. Another system within the vehicle may inform HUD 14 of which individual is currently driving vehicle, and such driver identification systems are known in the art. For example, the test of an individual driver's reaction brake time may include HUD 14 displaying a prompt on windshield 16 for the driver to apply the brakes, and measuring the elapsed time before the driver actually applies the brakes. As a further example, wheel sensor 20 and/or HUD 14 may take into account the level of ambient light or daylight outside the vehicle, as determined by a vehicle light sensor (e.g., similar to a sensor used to automatically turn on vehicle headlights) when estimating the driver's reaction brake time. For example, it may be assumed that the darker it is outside, the more difficult it may be for the driver to see an event calling for his braking, and thus increasing darkness may be assumed to increase the driver's reaction brake time, and thus increase the calculated length of line 30.

In another embodiment, the speed of the vehicle is determined by central processor 40 based on global position data received from GPS 42. Central processor 40 also calculates the vehicle stopping distance based on the speed of the vehicle. HUD 14 presents the vehicle stopping distance as calculated by central processor 40.

In another embodiment, the vehicle stopping distance is calculated based, at least in part, on empirical data collected on the current trip. The stopping distance may be dependent upon the weight of the passengers and truck contents, both of which may vary from trip to trip, so more accurate stopping distances may be obtained by considering the empirical data. Brake sensor 44 may detect the timing and magnitude of instances of braking, and the resulting decrease in speed of vehicle 11 may be determined based on data from GPS 42.

The invention has been described herein as presenting the image on a head up display. However, it is within the scope of the invention to present the image on any in-vehicle display, such as a display on a dashboard of the vehicle.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A heads up display arrangement for a motor vehicle, comprising:
a wheel;
a wheel sensor configured to sense a speed of rotation of the wheel;
a distance-sensing device configured to sense a distance between the motor vehicle and an other vehicle that is in front of the motor vehicle relative to a direction of travel of the motor vehicle;
a processor configured to receive the sensed speed of rotation of the wheel and to calculate dependent thereon a stopping distance of the motor vehicle; and
a heads up display configured to present an image indicative of both the calculated stopping distance of the motor vehicle and the sensed distance between the motor vehicle and the other vehicle.

2. The arrangement of claim 1 wherein the distance-sensing device comprises a radar device.

3. The arrangement of claim 1 wherein the processor is included in the heads up display.

4. The arrangement of claim 1 wherein the processor is included in the wheel sensor.

5. The arrangement of claim 1 further comprising an ambient outside temperature sensor and a moisture sensor, the processor being configured to calculate the stopping distance of the motor vehicle dependent upon readings from the ambient outside temperature sensor and the moisture sensor.

6. The arrangement of claim 1 further comprising a traction sensor, the processor being configured to calculate the stopping distance of the motor vehicle dependent upon readings from the traction sensor.

7. The arrangement of claim 1 further comprising an ambient light sensor, the processor being configured to calculate the stopping distance of the motor vehicle dependent upon readings from the ambient light sensor.

8. The arrangement of claim 1 wherein the heads up display is configured to test a driver to determine his reaction brake time, the processor being configured to calculate the stopping distance of the motor vehicle dependent upon the determined reaction brake time.

9. The arrangement of claim 1 wherein the image includes a horizontal line indicative of the calculated stopping distance of the motor vehicle.

10. The arrangement of claim 9 wherein the horizontal line has a length proportional to the calculated stopping distance of the motor vehicle.

11. The arrangement of claim 9 wherein the image includes a space between an end of the horizontal line and an indication of a position of the other vehicle, a width of the space being proportional to a difference between the calculated stopping distance of the motor vehicle and a distance between the motor vehicle and the other vehicle.

12. The arrangement of claim 1 wherein the image includes a first indication of a position of the motor vehicle and a second indication of a position of the other vehicle, a width of a space between the first indication and the second indication being proportional to the sensed distance between the motor vehicle and the other vehicle.

13. A method of operating a heads up display in a motor vehicle, comprising:
detecting a speed of rotation of a wheel of the motor vehicle;
sensing a distance between the motor vehicle and an other vehicle that is in front of the motor vehicle relative to a direction of travel of the motor vehicle;
calculating, dependent upon the detected speed of rotation of the wheel, a stopping distance of the motor vehicle; and
presenting on the heads up display an image indicative of both the calculated stopping distance of the motor vehicle and the sensed distance between the motor vehicle and the other vehicle.

14. The method of claim 13 wherein the distance is sensed by a radar device.

15. The method of claim 13 wherein the calculating is performed by a processor in the heads up display.

16. The method of claim 13 wherein the processor is performed by a processor in the wheel sensor.

17. The method of claim 13 wherein the stopping distance of the motor vehicle is calculated dependent upon weight of the motor vehicle as manufactured.

18. The method of claim 13 wherein the stopping distance of the motor vehicle is calculated dependent upon a level of traction of a roadway on which the motor vehicle is traveling.

19. The method of claim 13 wherein the stopping distance of the motor vehicle is calculated dependent a level of outside ambient light.

20. The method of claim 13 further comprising testing a driver to determine his reaction brake time, the stopping distance of the motor vehicle being calculated dependent upon the determined reaction brake time.

21. The method of claim 13 wherein the image includes a horizontal line indicative of the calculated stopping distance of the motor vehicle.

22. The method of claim 21 wherein the horizontal line has a length proportional to the calculated stopping distance of the motor vehicle.

23. The method of claim 21 wherein the image includes a space between an end of the horizontal line and an indication of a position of the other vehicle, a width of the space being proportional to a difference between the calculated stopping distance of the motor vehicle and a distance between the motor vehicle and the other vehicle.

24. The method of claim 13 wherein the image includes a first indication of a position of the motor vehicle and a second indication of a position of the other vehicle, a width of a space between the first indication and the second indication being proportional to the sensed distance between the motor vehicle and the other vehicle.

25. A heads up display arrangement for a motor vehicle, comprising:
means for sensing a speed of the motor vehicle;
a distance-sensing device configured to sense a distance between the motor vehicle and an other vehicle that is in front of the motor vehicle relative to a direction of travel of the motor vehicle;
a processor configured to receive the sensed speed of the motor vehicle and to calculate dependent thereon a stopping distance of the motor vehicle; and
a display device configured to present an image indicative of both the calculated stopping distance of the motor vehicle and the sensed distance between the motor vehicle and the other vehicle.
